(19) United States
(12) Patent Application Publication
(10) Pub. No.: US 2006/0104282 A1
(43) Pub. Date: May 18, 2006

(54) Mobile node (MN) discovery using the protocol for carrying authentication for network access (PANA) in a telecommunications network

(75) Inventor: Lila Madour, Kirkland (CA)

Correspondence Address: ALEX NICOLAESCU;Ericsson Canada Inc., Patent Department (EMC/QM/P), 8400 Decarie Blvd., Town Mount Royal, QC, H4P 2N2, CA

(73) Assignee: Telefonaktiebolaget L M Ericsson (publ)

(21) Appl. No.: 10/986,914

(22) Filed: Nov. 15, 2004

(51) Int. Cl. H04L 12/56

(52) U.S. Cl. 370/395.2

(57) ABSTRACT

Methods and corresponding telecommunications nodes are provided for exchanging PANA Authentication Agent (PAA) information during the phase of the link layer establishment between a packet data switching node (e.g. a CDMA2000 Packet Data Serving Node—PDSN) and a Mobile Node (MN). An Air Interface Origination message is sent from the MN to a Base Station (BS) with a request for a PAA address. The BS sends to the switching node a Registration Request message that also includes the request. The switching node replies with a Registration Reply message with a PAA address. The BS receives the message, and sends an Air Interface Origination Completion message with the PAA address to the MN. The MN can then contact the appropriate PAA using the received PAA address and start a PANA session through which the MN is authenticated and authorised before establishing a packet data session with the switching node.

### BACKGROUND OF THE INVENTION

1. Field of the Invention

The present invention relates to a method and system for carrying out a Mobile Node (MN) discovery in a telecommunications network.

2. Description of the Related Art

CDMA2000, also known as IMT-CDMA Multi-Carrier or IS-95, is a Code-Division Multiple Access (CDMA) version of the IMT-2000 standard developed by the International Telecommunication Union (ITU). The CDMA2000 standard is a third-generation (3G) mobile wireless technology allowing mobile nodes (e.g. mobile stations, wireless PDAs, etc) to access IP-based high-speed voice and data traffic over the CDMA-based cellular network. CDMA2000 can support mobile data communications at speeds ranging from 144 Kbps to 2 Mbps.

In order to fully recognize the advantages of the present invention, a short description of some technical concepts associated with CDMA2000 IP-based cellular telecommunications networks is required. A typical CDMA2000 network comprises a number of nodes including a plurality of Mobile Nodes (MNs), a plurality of Base Stations (BSs), one or more Packet Control Functions (PCFs) and one or more Packet Data Serving Nodes (PDSNs), or their equivalent. The BSs may be connected to the PCF, which is an entity in the CDMA2000 Radio Access Network (RAN) that controls the transmission of data packets between the BSs and the PDSN. The PCF is in turn connected with the PDSN.

In a CDMA2000 network, the PDSN provides access to the Internet, intranets and applications servers for MNs utilizing the CDMA2000 RAN. Acting as an access gateway, the PDSN provides simple IP and mobile IP access, Foreign Agent (FA) support, and packet transport for virtual private networking. It may also act as a client for an Authorization, Authentication, and Accounting server (AAA) and provides the MNs with a gateway to the IP network.

The AAA server of a CDMA2000 network intelligently controls access to network resources, enforces policies, audits the usage, and provides the information necessary to bill for the services accessed by the MNs. These combined processes are essential for effective network management and security.

In CDMA2000 networks, the Point-to-Point Protocol (PPP) is used for setting up data session between the MNs and the serving PDSN. PPP is a protocol for communication between two nodes using a serial interface. PPP uses the Internet Protocol (IP) and thus it is sometimes considered a member of the TCP/IP (Transfer control Protocol/Internet Protocol) suite of protocols. Relative to the Open Systems Interconnection (OSI) reference model, PPP provides layer 2 (data-link layer) service. Essentially, it packages a computer's TCP/IP packets and forwards them to a server where they can actually be put on the Internet. The use of PPP in CDMA2000 networks is defined in the Internet Engineering Task Force (IETF) Request for Comments (RFC) 1661, which is herein included by reference in its entirety, as a link layer protocol between the MN and the PDSN for the establishment of packet data sessions. In CDMA2000 networks, four types of packet data sessions may be established using PPP: Simple IPv4, Mobile IPv4, Simple IPv6 and Mobile IPv6, on which work in still in progress.

Recently, the 3G Partnership Project 2 (3GPP2) has accepted a work item that proposes the elimination of PPP from the CDMA2000 packet data system and its replacement with an IP level signaling for at least the following motivations:

PPP is a very old technology mainly designed for wire-line dial-up services and 3GPP2 is considering upgrading to a better-suited protocol;

High-Level Data Link Control (HDLC) like framing is a processor intensive task: according to a study made by Qualcomm Inc. for broadcast multicast service, HDLC-like framing is 62 times more computational intensive compared to packet based framing, which has been adopted as an option to support broadcast/multicast service in 3GPP2. The MN and the PDSN utilize a processor intensive procedure whereby they parse received data on an octet-by-octet basis for HDLC flags to determine higher layer packet boundaries. This operation could be rather performed at a hardware level. However, this requires the platform hardware to support HDLC, which is not the case with current PDSNs; and

PPP is based on peer-to-peer negotiation, which may cause high call setup delays. According to a recent benchmark, the average PPP call setup time is about 2.5 seconds, which is inappropriate for most applications used in CDMA2000 networks.

However, there is no other existing IETF-based protocol that provides all the capabilities of PPP, i.e. link layer negotiation, MN discovery, header compression negotiation, DNS IP address configuration, packet data session termination, and link layer echo test. Other protocols have recently been identified as IP access based protocols that may represent an alternative to PPP, but each one lacks one or more of the capabilities of PPP.

Recently, the IETF has considered using the Protocol for Carrying Authentication for Network Access (PANA) as one of the possible replacements for PPP for setting up data sessions in CDMA2000 networks. PANA involves two entities, a PANA Authentication Client (PAC) in the MN and a PANA Authentication Agent (PAA), typically in the PDSN, or connected thereto. An Enforcement point (EP) is an Access Router that provides per packet enforcement policies applied on the inbound and outbound traffic of the MN, although in some case the EP may also be implemented in the PDSN itself. PANA, as defined today in the IETF draft, is limited to carry Extensible Authentication Protocol (EAP) authentication between the PAC and the AAA through the PAA. Any EAP method can be transported, including the methods that allow bootstrapping for other protocols in the access network for encryption and data integrity, if so required by the operator.

It is known that in most cases access networks require some form of authentication in order to prevent unauthorized usage. In the absence of physical security (and sometimes in addition to it), a higher layer (L2+) access authentication mechanism is needed. Depending on the deployment scenarios, a number of features are expected from the authentication mechanism. For example, support for various authentication methods (e.g., MD5, TLS, SIM, etc.), network roaming, network service provider discovery and selection, separate authentication for access (L1+L2) service provider and Internet Service Provider (ISP, L3), etc. In the absence of a link-layer authentication mechanism that can satisfy these needs, operators are forced to either use non-standard ad-hoc solutions at layers above the link, insert additional shim layers for authentication, or misuse some of the existing protocols in ways that were not intended by design. PANA is proposed to be developed to fill this gap by defining a standard network-layer access authentication protocol. As a network-layer access authentication protocol, PANA can be used over any link-layer that supports IP.

PPP-based authentication could provide some of the required functionality. But using PPP for authentication is not a good choice, as it incurs additional messaging during the connection setup and extra per-packet processing, and it forces the network topology to a point-to-point model. Aside from using PPP in absence of any other suitable protocol, there is now an interest in the CDMA2000 community to remove PPP from some of the existing architectures and deployments.

The goal of PANA is to define a protocol that allows clients, such as MNs of a CDMA2000 network, to “discover” the address of the serving node so that communication can be established allowing the clients to be authenticated with the access network using IP protocols. Such a protocol would allow a client to interact with a AAA server to gain access without the need to understand the particular AAA server protocols in use at the site. It would also allow such interactions to take place without a link-layer specific mechanism. PANA would be applicable to both multi-access and point-to-point links. It would provide support for various authentication methods, dynamic service provider selection, and roaming clients. Mobile IPv4 developed its own protocols for performing PANA-like functions (e.g., MN-Foreign Agent (FA) interaction). Mobile IPv6 does not have the equivalent of an FA that would allow the access/visited network to authenticate the MN before allowing access. The PAA can perform the authentication function attributed to the FA in Mobile IPv4, in Mobile IPv6 networks.

Conclusively, PANA is being developed into an IP-based protocol that allows a device like an MN to discover the address of the serving node of the network, and then to authenticate itself with the network in order to be granted network access. In order to better understand the use of PANA, a short explanation of the PANA usual terminology may be appropriate:

PANA Session:

A PANA session begins with the initial handshake between the PANA Client (PaC) and the PANA Authentication Agent (PAA), and terminates by an authentication failure, a timeout, or an explicit termination message. A fixed session identifier is maintained throughout a session. A session cannot be shared across multiple physical network interfaces. A distinct PANA session is associated with the device identifiers of PAC and PAA.

Session Identifier:

This identifier is used to uniquely identify a PANA session on the PAA and PAC. It includes an identifier of the PAA, therefore it cannot be shared across multiple PAAs. It is included in PANA messages to bind the message to a specific PANA session. This bi-directional identifier is allocated by the PAA following the initial handshake and freed when the session terminates.

PANA Security Association:

A PANA security association is a relationship between the PAC and PAA, formed by the sharing of cryptographic keying material and associated context. Security associations are duplex. That is, one security association is needed to protect the bi-directional traffic between the PAC and the PAA.

PANA Client (PAC):

The client side of the protocol that resides in the host device, which is responsible for providing the credentials to prove its identity for network, access authorization.

Device Identifier (DI):

The identifier used by the network as a handle to control and police the network access of a client. Depending on the access technology, this identifier might contain any of IP address, link-layer address, switch port number, etc of a connected device.

PANA Authentication Agent (PAA):

The protocol entity in the access network side whose responsibility is to verify the credentials provided by a PANA client and grant network access service to the device associated with the client and identified by a DI. Note the authentication and authorization procedure can, according to the EAP model, be also offloaded to the backend AAA infrastructure.

Enforcement Point (EP):

A node on the access network where per-packet enforcement policies (i.e., filters) are applied on the inbound and outbound traffic of client devices. Information such as the DI and (optionally) cryptographic keys are provided by the PAA per client for constructing filters on the EP.

Network Access Provider (NAP):

A service provider that provides physical and link-layer connectivity to an access network it manages.

AAA-Key:

A key derived by the EAP peer and EAP server and transported to the authenticator.

In its current form, PANA lacks capabilities for insuring a proper alternative to PPP for the setup of data session in CDMA2000 networks. For example, in its current form, PANA does not define an effective mechanism allowing for the MN discovery of a PAA. Consequently, PANA as defined in IETF today is not sufficient, and additional capabilities, are required to convert it from just a transport mechanism for EAP packets into a suitable IP access protocol.

Although the industry is resolved to use PANA as a means for PAA discovery and for authenticating a CDMA2000 terminal for use in CDMA2000 packet data sessions, so far no optimized call scenarios have been proposed to this effect.

For example, reference is now made to FIG. 1 (Prior Art), which shows a nodal operation and signal flow diagram representing a CDMA2000 telecommunications network 100 implementing a known scenario for MN discovery of a PAA. Shown in FIG. 1, is first a CDMA2000 capable MN 102 that implements a PAC module 103, which is provided CDMA2000 radio coverage by a Base Station (BS) 104. The BS 104 is connected to a CDMA2000 serving PDSN 106 that comprises a PAA module 107. Finally, the PDSN 107 is connected to a AAA server 108 responsible for the authentication and authorization of the MNs served by the PDSN 106. In FIG. 1, the PAC 103 of the MN 102 discovers the PDSN's PAA 107 by either explicitly soliciting advertisements from the PDSN (e.g. using multicast messaging) or receiving unsolicited advertisements messages from the PDSN 106, action 110. For example, the PAC 103 discovers the PAA 107 by sending a PANA-PAA-Discover message 120 to a well-known link local multicast address and UDP (User Datagram Protocol) port associated with the PDSN 106. When the PAA 107 receives the PANA-PAA-Discover message 120 from the PAC 103, it sends a unicast PANA-Start-Request message 130 to the PAC 103. The PAC's answer message 140 sent in response to the PANA Start-Request message 130 starts a new PANA session, through which the MN 102 can be authenticated and authorized by the PDSN 106, in combination with the AAA 108, so that a packet data session can be finally established between he MN 102 and the PDSN 106.

However, it was observed that the present prior art scenario is ineffective and resource-demanding, since it first requires a link layer establishment phase 110 that contains extensive signaling exchanges between the PDSN 106 and the MN 102, and following the link layer establishment phase, a supplemental PANA PAA discovery phase 120.

Accordingly, it should be readily appreciated that in order to overcome the deficiencies and shortcomings of the existing solutions, it would be advantageous to have a method and system for effectively discovering the presence of a CDMA2000 mobile terminal in the area served by a node like a PDSN with PAA capability of the CDMA2000 network, which minimizes the amount of messages exchanged between the MN and the PDSN. The present invention provides such a method and system.

### SUMMARY OF THE INVENTION

In one aspect, the present invention is a method for exchanging information about a PANA (Protocol for Carrying Authentication for Network Access) Authentication Agent (PAA) in a telecommunications network, the method comprising the steps of:

a. receiving at a Packet Data Serving Node (PDSN) a Registration Request message comprising a request for a PAA address, the request being originated from a Mobile Node (MN); and

b. sending a Registration Reply message comprising a PAA address, the PAA address being destined to the MN.

In another aspect, the present invention is a method for exchanging information about a PANA (Protocol for Carrying Authentication for Network Access) Authentication Agent (PAA) in a telecommunications network, the method comprising the steps of:

a. receiving at a Base Station (BS) an Air Interface Origination Message comprising a request for a PAA address, the message being originated from a Mobile Node (MN);

b. sending from the BS to a Packet Data Serving Node (PDSN) a Registration Request message comprising the request for a PAA address;

c. receiving at the BS a Registration Reply message from the PDSN, the Registration Reply message comprising a PAA address, the PAA address being destined to the MN; and

d. sending from the BS to the MN an Air Interface Origination Completion message comprising the PAA address.

In another aspect, the present invention is a method for exchanging information about a PANA (Protocol for Carrying Authentication for Network Access) Authentication Agent (PAA) in a telecommunications network, the method comprising the steps of:

a. sending from a Mobile Node (MN) an Air Interface Origination Message comprising a request for a PAA address; and

b. receiving at the MN an Air Interface Origination Completion message comprising the PAA address.

In another aspect, the present invention is a Packet Data Serving Node (PDSN) comprising:

a link layer module acting to receive a Registration Request message comprising a request for a PAA address, the request being originated from a Mobile Node (MN); and

wherein the link layer module further acts to send a Registration Reply message comprising a PAA address, the PAA address being destined to the MN.

In another aspect, the present invention is a Base Station (BS) comprising:

a link layer module receiving from a Mobile Node (MN) an Air Interface Origination message comprising a request for a PAA address and responsive to the Air Interface Origination message sending to a Packet Data Serving Node (PDSN) a Registration Request message comprising the request for a PAA address;

wherein the link layer module receives back from the PDSN a Registration Reply message comprising a PAA address, the PAA address being destined to the MN, and further sends to the MN an Air Interface Origination Completion message comprising the PAA address.

In another aspect, the present invention is a Mobile Node (MN) comprising:

a link layer module acting to send an Air Interface Origination Message comprising a request for a PAA address;

wherein the link layer module receives back an Air Interface Origination Completion message comprising the PAA address.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 (Prior Art) is a nodal operation and signal flow diagram representing a CDMA2000 telecommunications network implementing a known scenario for Mobile Node (MN) discovery;

FIG. 2 is a nodal operation and signal flow diagram representing an exemplary CDMA2000 telecommunications network implementing the preferred embodiment of the present invention; and

FIG. 3 is a high-level representation of an Air Interface Origination message comprising three variants of a request for a PANA (Protocol for Carrying Authentication for Network Access) Authentication Agent (PAA).

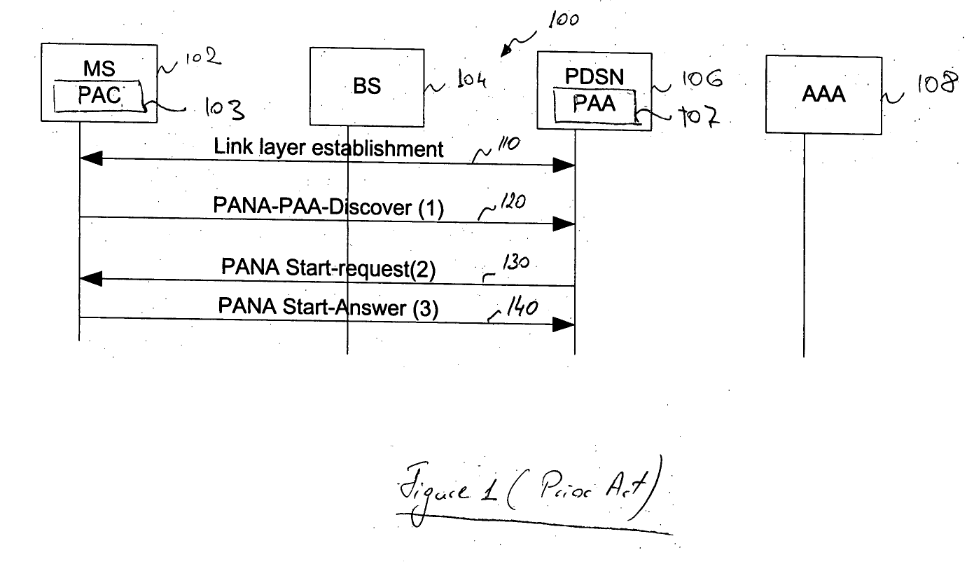

### DETAILED DESCRIPTION OF THE PREFERRED EMBODIMENTS

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

To use PANA, a PANA client (PAC) in the MN and a PANA Authentication Agent (PAA) in the PDSN, or connected thereto, are required. The current invention is directed at defining a method and system for including in the link layer establishment phase the transmission of the PAC's request for a PAA, so that the PAC can be assigned a PAA without the need of an additional PANA PAA discovery phase like in the prior art. Afterwards, the PAA and PAC may enter the authentication phase where, for example, EAP messages are exchanged therebetween to authenticate the MN.

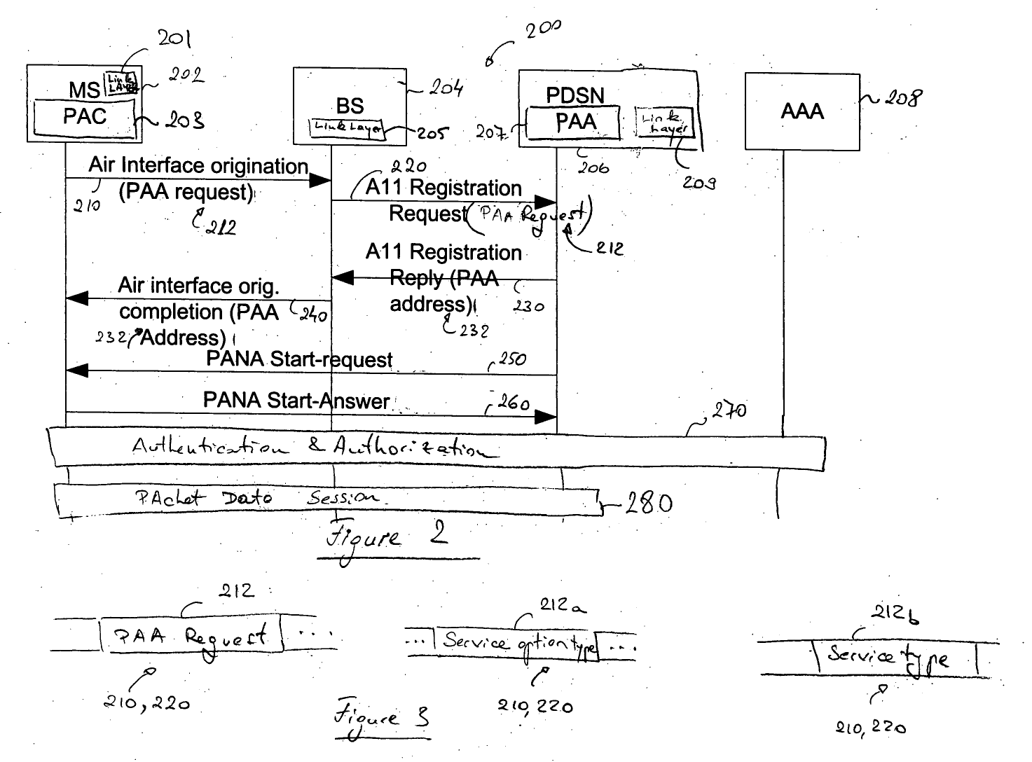

Reference is now made to FIG. 2, which is a nodal operation and signal flow diagram representing an exemplary CDMA2000 telecommunications network 200 implementing the preferred embodiment of the present invention. It is to be noted that although the exemplary preferred embodiment of the present invention is herein described with reference to a CDMA2000 network 200, the preset invention is not restricted thereto, and may be advantageously implemented in other types of cellular networks, such as for example in GRPS/UMTS (General Packet Radio Service and/or Universal Mobile Telephone System) networks, when PANA is used as a means for authenticating the MN. Shown in the exemplary FIG. 2, is first a CDMA2000 capable MN 202 that implements a PAC module 203 and a link layer module 201, which is capable of setting up, operating and tearing down link layer connections (air interface connections). The MN 202 is provided CDMA2000 radio coverage by a Base Station (BS) 204. The BS 204 also comprises a link layer module 205 capable of setting up, operating and tearing down link layer connections. The BS 204 is connected to a CDMA2000 serving PDSN 206 that comprises a PAA module 207 and a link layer module 209, which is also capable of setting up, operating and tearing down link layer connections. Finally, the PDSN 207 is connected to a AAA server 208 responsible for the authentication and authorization of the MNs served by the PDSN 206.

According to the preferred embodiment of the present invention, in order to reduce the PANA session setup time when the first contact is established between an MN and the serving PDSN, the link layer establishment phase also transfers the PAA information to the MN, so that the MN is informed of which PAA to contact for establishing the PANA session. The MN may be a 3G1x (3^{rd} Generation 1x air interface for voice and data) or an HRPD 1x (High Rate Packet Data air interface). Therefore, when the MN requests the establishment of a new packet data connection, the appropriate air interface messages are used and incorporate the request for, and the exchange of the PAA identity information. For example, in action 210, the MN 202 sends an Air Interface Origination message including an indication 212 that a PAA address is requested by the MN 202. Reference is now made jointly to FIG. 3, which is a high-level representation of the Air Interface Origination message 210 comprising three variants of the PAA Request 212. In FIG. 3 first, a generic PAA Request 212 is shown. Such a request may comprise, in the case of 3G1x MN, a new service option type 212a in the message 210 (second example of FIG. 3), while in the case of HRPD it can include a service type parameter 212b (last example of FIG. 3). With reference being made back to FIG. 2, upon receipt of message 212, the link layer module 205 of the BS 204 verifies the incoming message 210 and determines that a request for a PAA address 212 is present. The link layer module 205 of the BS 204 requests the establishment of an A11 connection by sending an A11 Registration-Request message 220 to the PDSN 206, the request 220 including the PAA request 212 received from the MN 202, which may take the same forms described with reference to FIG. 3. The link layer module 209 of the PDSN 206 receives the PAA Request 212 of message 220, and responds back to the BS 204 by including a PAA address 232 into an A11 Registration Reply message 230 sent to the BS 204. Alternatively, if the PAA to be used by the MN 202 is not collocated with the PDSN 206 like in the present exemplary scenario, the PAA address parameter 232 contained in the message 230 may be the address of another PAA, which is not collocated with the PDSN 206, but which identity is known to the PDSN 206. The link layer module 205 of the BS 204 provides the PAA address 232 further to the MN 202 in an appropriate Air Interface Origination Completion message 240, which actual type may depend on the access type.

At this point, because the MN 202, and in particular the PAC 202 of the MN 202 is informed of the address of the PAA 207 of the serving PDSN 206 (or of any other PAA to be used), the PANA session can start. This is confirmed with the exchange of messages PANA Start Request message 250 and the PANA Start Answer message 260, which indicate the beginning of the PANA-based authentication phase. The messages 250 and 260 also include a sequence number used to, track the PANA messages that are exchanged (not shown). The PANA session continues with the MN's authentication and authorization, action 270, in view of the establishment of a new packet data session between the PDSN 206 and the MN 202, which is achieved in action 280.

Therefore, with the present invention it becomes possible to substantially reduce the signalling associated with the prior art discovery method of a PAA for use by an MN in a CDMA200 network, by removing the need for using a PANA PAA discover signalling.

Based upon the foregoing, it should now be apparent to those of ordinary skills in the art that the present invention provides an advantageous solution, which offers an optimized and efficient discovery phase of an MN served by a switching node like a PDSN. Although the system and method of the present invention have been described in particular reference to the CDMA2000 it should be realized upon reference hereto that the innovative teachings contained herein are not necessarily limited thereto and may be implemented advantageously with any other communications protocol that makes use of PANA for the authentication and authorization of a terminal like an MN, such as for example with GPRS or UMTS. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for exchanging information about a PANA (Protocol for Carrying Authentication for Network Access) Authentication Agent (PAA) in a telecommunications network, the method comprising the steps of:
a. receiving at a Packet Data Serving Node (PDSN) a Registration Request message comprising a request for a PAA address, the request being originated from a Mobile Node (MN); and
b. sending a Registration Reply message comprising a PAA address, the PAA address being destined to the MN.

2. The method claimed in claim 1, further comprising the steps of:
c. establishing a PANA session between the MN and the PDSN;
d. authenticating and authorising the MN; and
e. establishing a packet data session between the MN and the PDSN.

3. The method claimed in claim 1, wherein:
the Registration Request message comprises an A11 Registration Request message sent from a Base Station (BS); and
the Registration Reply message comprises and A11 Registration Reply message sent to the BS.

4. The method claimed in claim 1, wherein the request for a PAA address comprises a service option type.

5. The method claimed in claim 1, wherein the request for a PAA address comprises a service type parameter.

6. A method for exchanging information about a PANA (Protocol for Carrying Authentication for Network Access) Authentication Agent (PAA) in a telecommunications network, the method comprising the steps of:
a. receiving at a Base Station (BS) an Air Interface Origination Message comprising a request for a PAA address, the message being originated from a Mobile Node (MN);
b. sending from the BS to a Packet Data Serving Node (PDSN) a Registration Request message comprising the request for a PAA address;
c. receiving at the BS a Registration Reply message from the PDSN, the Registration Reply message comprising a PAA address, the PAA address being destined to the MN; and
d. sending from the BS to the MN an Air Interface Origination Completion message comprising the PAA address.

7. The method claimed in claim 6, further comprising the steps of:
e. establishing a PANA session between the MN and the PDSN;
f. authenticating and authorising the MN; and
g. establishing a packet data session between the MN and the PDSN.

8. The method claimed in claim 6, wherein:
the Registration Request message comprises an A11 Registration Request message sent from a Base Station (BS); and
the Registration Reply message comprises and A11 Registration Reply message sent to the BS.

9. The method claimed in claim 6, wherein the request for a PAA address comprises a service option type.

10. The method claimed in claim 6, wherein the request for a PAA address comprises a service type parameter.

11. A method for exchanging information about a PANA (Protocol for Carrying Authentication for Network Access) Authentication Agent (PAA) in a telecommunications network, the method comprising the steps of:
a. sending from a Mobile Node (MN) an Air Interface Origination Message comprising a request for a PAA address; and
b. receiving at the MN an Air Interface Origination Completion message comprising the PAA address.

12. The method claimed in claim 11, further comprising the steps of:
e. establishing a PANA session between the MN and the PDSN;
f. authenticating and authorising the MN; and
g. establishing a packet data session between the MN and the PDSN.

13. The method claimed in claim 11, wherein the request for a PAA address comprises a service option type.

14. The method claimed in claim 11, wherein the request for a PAA address comprises a service type parameter.

15. A Packet Data Serving Node (PDSN) comprising:
a link layer module acting to receive a Registration Request message comprising a request for a PAA address, the request being originated from a Mobile Node (MN); and
wherein the link layer module further acts to send a Registration Reply message comprising a PAA address, the PAA address being destined to the MN.

16. The PDSN claimed in claim 15, further comprising:
a PANA (Protocol for Carrying Authentication for Network Access) Authentication Agent (PAA) module that establishes a PANA session between the MN and the PDSN;
wherein the PANA session is used to authenticate and authorise the MN before establishing a packet data session between the MN and the PDSN.

17. The PDSN claimed in claim 15, wherein:
the Registration Request message comprises an A11 Registration Request message sent from a Base Station (BS); and
the Registration Reply message comprises and A11 Registration Reply message sent to the BS.

18. The PDSN claimed in claim 15, wherein the request for a PAA address comprises a service option type.

19. The PDSN claimed in claim 15, wherein the request for a PAA address comprises a service type parameter.

20. A Base Station (BS) comprising:
a link layer module receiving from a Mobile Node (MN) an Air Interface Origination message comprising a request for a PAA address and responsive to the Air Interface Origination message sending to a Packet Data Serving Node (PDSN) a Registration Request message comprising the request for a PAA address;
wherein the link layer module receives back from the PDSN a Registration Reply message comprising a PAA address, the PAA address being destined to the MN, and further sends to the MN an Air Interface Origination Completion message comprising the PAA address.

21. The BS claimed in claim 20, wherein:
the Registration Request message comprises an A11 Registration Request message sent from a Base Station (BS); and
the Registration Reply message comprises and A11 Registration Reply message sent to the BS.

22. The BS claimed in claim 20, wherein the request for a PAA address comprises a service option type.

23. The BS claimed in claim 20, wherein the request for a PAA address comprises a service type parameter.

24. A Mobile Node (MN) comprising:
a link layer module acting to send an Air Interface Origination Message comprising a request for a PAA address;
wherein the link layer module receives back an Air Interface Origination Completion message comprising the PAA address.

25. The MN claimed in claim 24, wherein the request for a PAA address comprises a service option type.

26. The MN claimed in claim 24, wherein the request for a PAA address comprises a service type parameter.
